(19) United States
(12) Patent Application Publication
(10) Pub. No.: US 2006/0061504 A1
(43) Pub. Date: Mar. 23, 2006

(54) Through wall detection and tracking system

(75) Inventors: Richard R. Leach JR., Castro Valley, CA (US); Patrick A. Welsh, Manteca, CA (US); John T. Chang, Danville, CA (US)

Correspondence Address: Eddie E. Scott;Assistant Laboratory Counsel, Lawrence Livermore National Laboratory, L-703, P.O. Box 808,, Livermore, CA, 94551, US

(73) Assignee: The Regents of the University of California

(21) Appl. No.: 10/950,209

(22) Filed: Sep. 23, 2004

(51) Int. Cl. G01S 13/88; G01S 13/62

(52) U.S. Cl. 342/22; 342/28; 342/97; 342/27

(57) ABSTRACT

A system for detecting and tracking an individual or animal comprises producing a first return radar signal from the individual or animal with a first low power ultra wideband radar. Producing a second return radar signal from the individual or animal with a second low power ultra wideband radar. Maintaining the first low power micro-power radar a fixed distance from the second low power ultra wideband radar. Processing the first return radar signal and the second return radar signal in detecting and tracking of the individual or animal.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to a tracking system and more particularly to a through wall detection and tracking system.

2. State of Technology

United Kingdom Patent Application No. GB2383214 by David Brown, published Jun. 18, 2003, provides the following state of technology information, “In order to determine the location of a person within a building or facility, a number of radio frequency transceivers are positioned at fixed locations throughout the facility and each person is provided with a portable radio frequency transceiver. Each of the fixed transceivers is operable to communicate the identity of one or more portable transceivers located within communications range of a fixed transceiver to a central processing unit. The coverage area provided by the transceivers within a facility may be remotely or automatically adjusted. The location of an individual may be determined by a triangulation process. The fixed position transceivers may be arranged in cells comprising a number of pico-net masters and further scatter-net masters arranged to relay information to a central processing unit. The transceivers may be operated in accordance with the Bluetooth RTM communications protocol. The system may be arranged to track movements of individuals via the use of a video-surveillance system; remotely control the operation of a device within the vicinity of an individual; monitor the locations of a number of people within an airport; monitor the location of an isolated worker whereby in the event of an provided to the central processing unit via a fixed transceiver.”

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides a system for detecting and tracking an individual or animal. Fractional bandwidth of any radar system is defined as the radar system bandwidth divided by its center or carrier frequency. Ultra wideband (UWB) radar is defined as any radar system that has a fractional bandwidth greater than 0.25. The radar in the system typically has a fractional bandwidth greater than 1. The system comprises producing a return or reflected radar signal from the individual or animal with a first low power ultra wideband radar. Producing a second return or reflected radar signal from the individual or animal with a second low power ultra wideband radar. Maintaining the first low power micro-power radar a fixed distance from the second low power ultra wideband radar. Processing the first return radar signal and the second return radar signal in detecting and tracking of the individual or animal. One embodiment of the present invention provides a system for detection and tracking of an individual or animal comprising a first low power ultra wideband radar unit that produces a first return radar signal from the individual or animal, a second low power ultra wideband radar unit that produces a second return radar signal from the individual or animal, the second low power micro-power radar unit located a fixed distance from the first low power ultra wideband radar unit, and a processing system for the first and the second return radar signal for detection and tracking of the individual or animal. Although the system is described using two radar units, third, fourth, fifth, etc. radar units may be added to enhance performance. Examples of added performance include, but are not limited to, coverage area, resolution, and signal strength.

Urban warfare, terrorism, military operations, police raids, and search and rescue efforts are becoming more and more commonplace. The detection and tracking system of the present invention will allow police, military, or rescue forces to detect the presence and location of individuals behind obstructions. The detection and tracking system will also allow rescue forces to detect and locate survivors buried in rubble at extended distances. This can be where urban infrastructures have been damaged or destroyed by man-made or natural means. The detection and tracking system can also be used in other rescue operations such as avalanches, bombs, and earthquakes. The detection and tracking system has other uses, for example the system can be used by firefighters to monitor and keep track of individual firefighters in burning buildings through obscurants such as smoke, mist, and fog.

The sensor system can be used to detect multiple targets. The algorithms for this process include, but are not limited to: velocity filters to extract antenna reflections and spatially consistent multi-pathing; motion characterization to remove suspected targets exhibiting unlikely motion behavior; and adaptive-filters, such as the Kalman filter, to localize secondary targets amid increased noise.

To facilitate more complex algorithms, the system can be implemented on advanced hardware such as an FPGA. This hardware implementation will allow processed data to be displayed in excess of NTSC video frame rates (30 frames per second). This implementation has the further advantages of increasing the portability and decreasing the cost of the final system.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 illustrates a detection and tracking system that incorporates an embodiment of the present invention.

FIG. 2 is an iconic display that provides an illustration of the detection and tracking system of the present invention.

FIG. 3 illustrates another detection and tracking system that incorporates an embodiment of the present invention.

FIG. 4 illustrates yet another detection and tracking system that incorporates an embodiment of the present invention.

FIG. 5 shows an embodiment of the remotely located central processor used in the detection and tracking system of the present invention.

FIG. 6 illustrates a detection and tracking system that incorporates another embodiment of the present invention.

FIG. 7 shows a block diagram illustrating signal and image processing algorithms used in the detection and tracking system of the present invention.

### DETAILED DESCRIPTION OF THE INVENTION

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

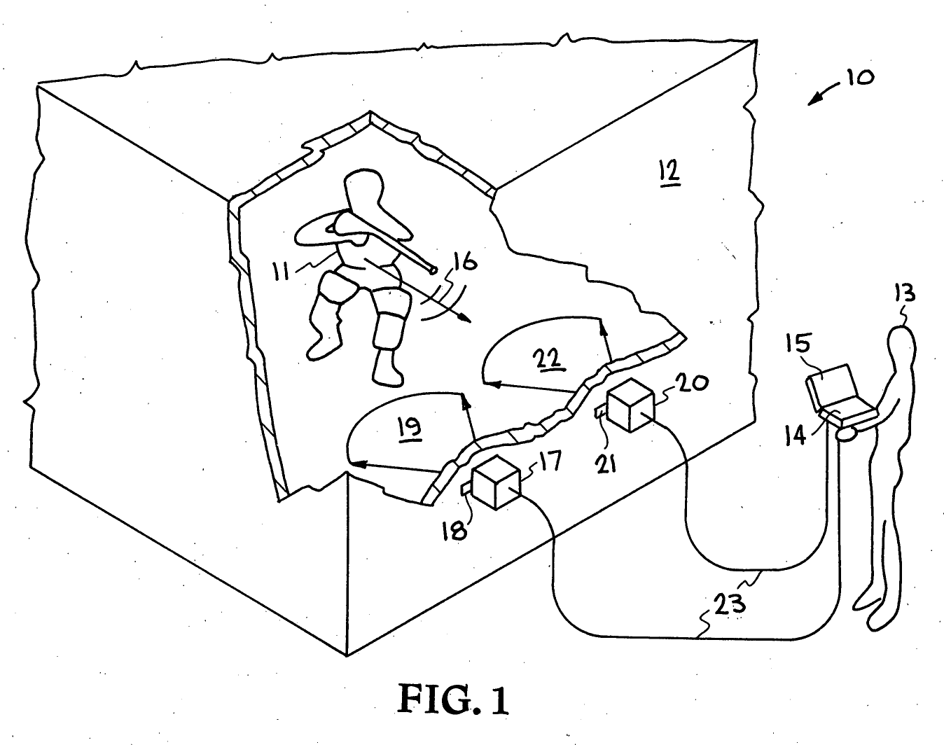

Referring now to FIG. 1, a detection and tracking system that incorporates an embodiment of the present invention is illustrated. The detection and tracking system 10 is capable of detecting and tracking a moving human target 11 at extended distances through light construction materials 12. Examples of the light construction material 12 include wooden doors, sheetrock, two-by-four frame construction, adobe, cinder block, brick, etc.

The detection and tracking system 10 utilizes a first radar unit 17 that provides an estimate of range to target. The first radar unit 17 is positioned at a fixed distance outside a wall of the building 12. This may be accomplished by a fixation device 18 such as peel and strip Velcro, a suction cup, a barbed arrow head, etc. The first radar unit 17 provides a sweeping radar beam 19 that provides an estimate of range to target.

A second radar unit 20 that provides an estimate of range to target is positioned a fixed distance from the first radar unit 17. The second radar unit 20 is affixed to the wall of the building 12. This may be accomplished by a fixation device 21 such as peel and strip Velcro, a suction cup, a barbed arrow head, etc. The second radar unit 20 provides a sweeping radar beam 22 that provides an estimate of range to target. The second radar unit 20 gives a second, different, estimate of range to target. The first radar unit 17 and the second radar unit 20 are connected together and connected to the processing unit 14 by wires 23. Instead of wires 23 the units can be connected by wireless units.

The radar may also be positioned with some offset distance from the wall at a standoff distance that can vary from the maximum range of the radar to installing the radar inside the wall. The variable standoff distance of the radar is fixed for a given embodiment, but can change for different applications. The radar can also be mounted on a mechanically moving device to alter its position with respect to the barrier of interest.

The first radar unit 17 and the second radar unit 20 provide sweeping radar beams that provides an estimate of range to target. They are small, low power ultra wideband radar units. The radar units 17 and 20 have the following features: dual channel radar; low-power; modular design; standardized (USB) interface; swept-range gating radar sensors; center frequency 2.4 GHz; bandwidth ˜3 GHz; pulse repetition rate 4 MHz; pulse length ˜12 ns; duty cycle ˜20%; tuned antenna; high speed data transmitted from UWB radars to remote laptop or PDA; stem frame rate dependant on link data rate up to 1 Mbit/second; UWB radars sensitive to high-power radio frequency interference near their center frequency of ˜1.9 GHz; data link is robust and capable of non-line-of-sight (LOS) communications over a distance of several hundred feet; and wireless communications. The radar units 17 and 20 have the specifications set out in Table 1.

TABLE 1

| | |
|---|---|
| Antenna pattern (H-plane) | 160° cavity-backed monopole |
| | (narrower w/horn/reflector/lens) |
| Center frequencies available | 0.9 to 5.8 GHz + 10% |
| Duty cycle | <1% |
| PRF (average) | 4 MHz + 20% |
| PRF coding | none |
| Receiver noise floor | <5e−6 V rms |
| Receiver gate width | 100 ps for 1.95 GHz system |
| Range delay | Quartz based timing system |
| Analog output | 4 V peak to peak bipolar |
| Receiver gain | 60 dB |
| Size | 5″ × 3″ rectangular SMT PCB |
| | with 1.5″ long wire dipole elements |

The detection and tracking system 10 uses return the radar signals 16 to track motion. The radar analog voltage output signal is proportional to reflected energy at a set range. Signal and image processing algorithms are performed on a standard notebook computer, embedded DSP processor or similar device 14. A graphical users interface 15 for the operator 13 will allow clear discrimination of targets in real-time as well as present a history of motion over past seconds. The detection and tracking system 10 will display dominant motion in a horizontal plane at the sensor height and motion history in real-time. The screen 15 will be calibrated and display units of distance as well as processed radar signals will be seen as subplots.

The radar analog signals are digitized and used to triangulate and locate moving objects. The location estimate is then used to focus the radar to the location of the moving subject. A spectral estimation algorithm is then applied to provide detection and estimation of the human heartbeat and respiration signature (HRS) for that location. The radar antenna separation can be mechanically adjusted for a variety of angular resolutions. The field of view of the two radar units 17 and 20 comprises a radar lobe in the form of a plane parallel to the floor at or near the height of the radar antenna whose edges are determined by the antenna separation and field of view. A typical setting would provide coverage of an average sized room. Higher power systems can cover larger areas. All motion in the field of view is analyzed and therefore multiple people will produce multiple locations and HRS signatures. Estimates are updated fifteen times per second or faster. The information is displayed on a computer monitor screen or similar device. Display consists of an image representing motion in the room with icons or image highlighting to indicate locations of human subjects. Heartbeat and respiration rate estimates are also displayed for each location.

An azimuth estimate of a moving object can be calculated by signal and image filtering algorithms using multiple frame processing, non-stationary signal processing techniques, and triangulation using methods such as the Law of Cosines. This gives the ability to track a moving object precisely in space. Tracking the object allows focusing the range gate of a radar unit continuously to the moving target. This, in turn allows the continuous integration of localized spatial motion activity. Spectral estimation techniques are then used to estimate heartbeat and respiration rates.

The detection and tracking system 10 includes a geo-location system for detection and tracking of the individual or animal. Geo-location data for detected targets is provided by coupling known (radar location) position with target estimates for embodiments such as satellite-based and terrestrial radio frequency (RF) tracking applications. System can used in concert with existing geolocation systems such as satellite-based devices that use GPS or other means for geolocation via low-earth-orbit and geosynchronous satellites.

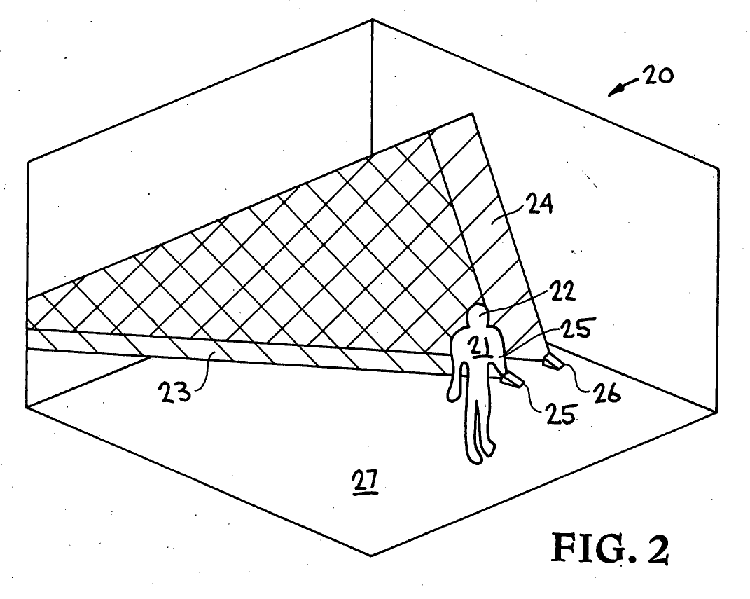

Referring now to FIG. 2, an iconic display is shown that provides an illustration of the detection and tracking system of the present invention. The iconic display is designated generally by the reference numeral 20. An individual 21 with head 22 and arm 25 is shown in the iconic display 20.

The detection and tracking system of the present invention tracks dominant motion in a plane parallel to the floor 27. Movement of the individual 21 is illustrated by the two shaded areas 23 and 24. As illustrated in FIG. 2, the individual's arm 25 is monitored by the detection and tracking system 10. The individual's arm moves from position 25 to position 26 and the movement is illustrated by the two shaded areas 23 and 24. Motion at a set distance can be monitored in real time through non-metallic barriers like wooden doors, drywall, rubble, etc.

The detection and tracking system of the present invention utilizes a processor and screen such as the processor 14 shown in FIG. 1, to provide a user interface. Dominant motion is tracked using the ionic display 20 translated to an overhead view. The user interface shows the location of the dominant motion and history of motion.

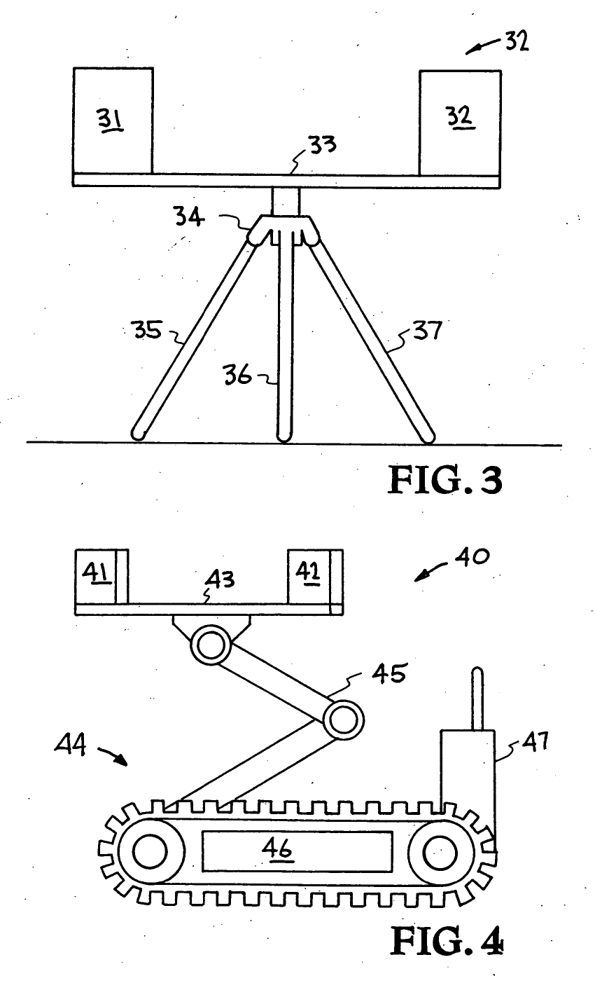

Referring now to FIG. 3, another detection and tracking system that incorporates an embodiment of the present invention is illustrated. This embodiment of the detection and tracking system is generally designated by the reference numeral 30. The detection and tracking system 30 is capable of detecting and tracking a target at extended distances through light construction materials.

The detection and tracking system 30 utilizes a first radar unit 31 that provides an estimate of range to target. The first radar unit 31 provides a sweeping radar beam that provides an estimate of range to target. A second radar unit 32 provides an estimate of range to target. The second radar unit 32 provides a sweeping radar beam that provides an estimate of range to target. The second radar unit 32 gives a second, different, estimate of range to target. The first radar unit 31 and the second radar unit 32 are mounted on a frame 33 at fixed distance apart. The frame 33 and the first radar unit 31 and the second radar unit 32 are mounted on a tripod 34 with legs 35, 36, and 37. The first radar unit 31 and the second radar unit 32 include wireless units that communicate with a central processor.

The first radar unit 31 and the second radar unit 32 are small, low power ultra wideband radar units as previously described. They utilize sweeping radar beams that provide an estimate of range to target. The frame 33 with the radar units 31 and 32 can be carried a placed near or against a wall or door of the area that is to be investigated.

Referring now to FIG. 4, another detection and tracking system that incorporates an embodiment of the present invention is illustrated. This embodiment of the detection and tracking system is generally designated by the reference numeral 40. The detection and tracking system 40 is capable of detecting and tracking a target at extended distances through light construction materials.

The detection and tracking system 40 utilizes a first radar unit 41 that provides an estimate of range to target. The first radar unit 41 provides a sweeping radar beam that provides an estimate of range to target. A second radar unit 42 provides an estimate of range to target. The second radar unit 42 provides a sweeping radar beam that provides an estimate of range to target. The second radar unit 42 gives a second, different, estimate of range to target. The first radar unit 41 and the second radar unit 42 are mounted on a frame 43 at fixed distance apart. The first radar unit 17 and the second radar unit 20 are small, low power ultra wideband radar units as previously described. They utilize sweeping radar beams that provide an estimate of range to target.

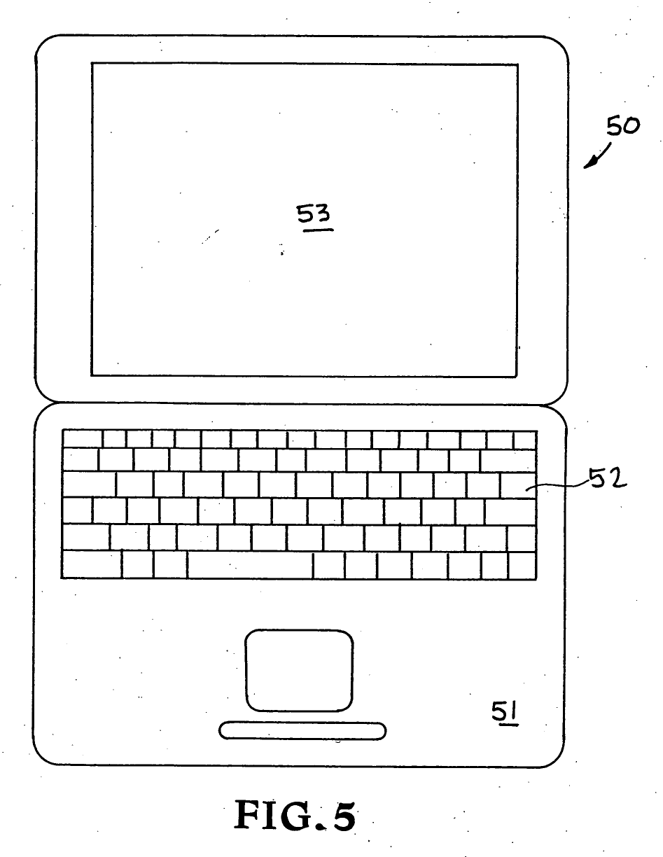

The frame 43 and the first radar unit 41 and the second radar unit 42 are mounted on a robot vehicle 44. The robot vehicle includes a remotely adjustable arm 45 for positioning the first radar unit 41 and the second radar unit 42 at the desired position and height on a wall or door of the area that is to be investigated. The robot vehicle includes a central unit 46 that controls the robot vehicle and includes a wireless unit that communicates with a remotely located central processor illustrated in FIG. 5.

Referring now to FIG. 5, an embodiment of the remotely located central processor used in the detection and tracking system of the present invention illustrated. The central processor is designated generally by the reference numeral 50. The central processor 50 is a tablet PC; however, the central processor 50 can be a laptop or other type of PC or central processor.

The central processor 50 provides an iconic display on the screen 53. Movement of an individual can be monitored. As the individual moves from position to position, the movement is illustrated on the screen 53. Motion at a set distance can be monitored in real time.

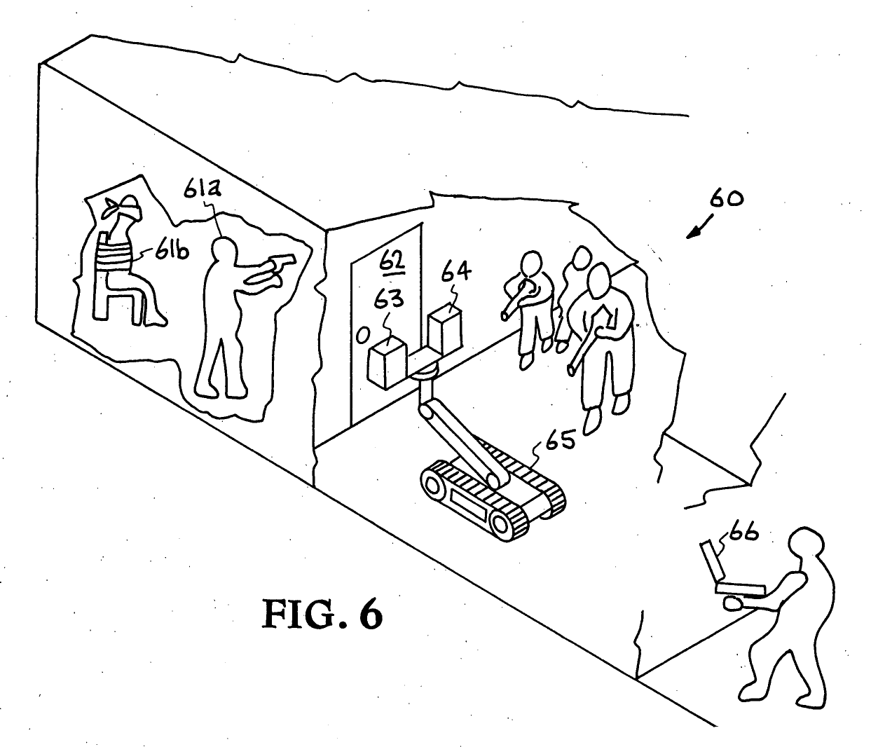

Referring now to FIG. 6, another embodiment of detection and tracking system of the present invention is illustrated. This embodiment of the detection and tracking system is generally designated by the reference numeral 60. Urban warfare, terrorism, military operations, police raids, and search and rescue efforts are becoming more and more commonplace. The detection and tracking system 60 will allow police, military or other rescue forces to detect the presence and location of individuals behind obstructions.

The detection and tracking system 60 is capable of detecting and tracking individuals 61A and 61B at extended distances the doors 62 or other light construction material such as sheetrock, two-by-four frame construction, adobe, cinder block, brick, etc.

The detection and tracking system 60 utilizes a first radar unit 63 that provides an estimate of range to target. The first radar unit 63 provides a sweeping radar beam that provides an estimate of range to target. A second radar unit 64 provides an estimate of range to target. The second radar unit 64 provides a sweeping radar beam that provides an estimate of range to target. The second radar unit 64 gives a second, different, estimate of range to target. The first radar unit 63 and the second radar unit 64 are mounted on a frame at fixed distance apart. The first radar unit 63 and the second radar unit 64 are small, low power ultra wideband radar units as previously described. They utilize sweeping radar beams that provide an estimate of range to target.

The frame and radar units 63 and 64 are mounted on a robot vehicle 65. The robot vehicle 65 includes a remotely adjustable arm for positioning the radar units at the desired position and height on the door 62. The robot vehicle 65 includes a central unit that controls the robot vehicle and includes a wireless unit that communicates with a remotely located central processor 66.

The detection and tracking system 60 utilizes the first radar unit 63 that provides an estimate of range to target. The first radar unit 63 provides a sweeping radar beam that provides an estimate of range to target.

A second radar unit 64 that provides an estimate of range to target is positioned a fixed distance from the first radar unit 63. The second radar unit 64 gives a second, different, estimate of range to target. The first radar unit 63 and the second radar unit 64 are connected to the processing unit 66 by wireless communication units.

The detection and tracking system 60 uses return the radar signals to track motion. The radar analog output signal is proportional to motion at a set range. Signal and image processing algorithms are performed on a standard notebook computer, embedded DSP processor or similar device. A graphical users interface for the operator will allow clear discrimination of targets in real-time as well as present a history of motion over past seconds. The detection and tracking system 60 will display dominant motion in a horizontal plane at the sensor height and motion history in real-time. The screen will be calibrated and display units of distance as well as processed radar signals will be seen as subplots.

The radar analog signals are digitized and used to triangulate and locate moving objects. The location estimate is then used to focus the radar to the location of the moving subject. A spectral estimation algorithm is then applied to provide detection and estimation of the human heartbeat and respiration signature (HRS) for that location. The radar antenna separation can be mechanically adjusted from two to tens of inches for a variety of angular resolutions. The field of view of the two radar units 63 and 64 comprises a plane parallel to the floor at or near the height of the radar antenna whose edges are determined by the antenna separation and field of view. A typical setting would provide coverage of an average sized room. All motion in the field of view is analyzed and therefore multiple people will produce multiple locations and HRS signatures. Estimates are updated thirty times per second or faster. The information is displayed on a computer monitor screen or similar device. Display consists of an image representing motion in the room with icons or image highlighting to indicate locations of human subjects. Heartbeat and respiration rate estimates are also displayed for each location.

An azimuth estimate of a moving object can be calculated by signal and image filtering algorithms using multiple frame processing, non-stationary signal processing techniques, and triangulation using methods such as the Law of Cosines. This gives the ability to track a moving object precisely in space. Tracking the object allows focusing the range gate of a radar unit continuously to the moving target. This, in turn allows the continuous integration of localized spatial motion activity. Spectral estimation techniques are then used to estimate heartbeat and respiration rates.

Many devices and inventions efficacy becomes limited in the presence of human motion. In medicine, EEG recorders or pulse oxymetry machines are two examples. The present invention is designed to make use of motion artifacts by monitoring the differential spatial energy using ultra wideband radar devices. This approach has clear advantages as radar has the capability to penetrate through light construction materials, such as sheetrock, two-by-four frame construction, etc. This allows motion monitoring through typical walls, doors, and other non-metallic barriers. A second advantage is that ultra wideband radar is small, lightweight, and uses very little power.

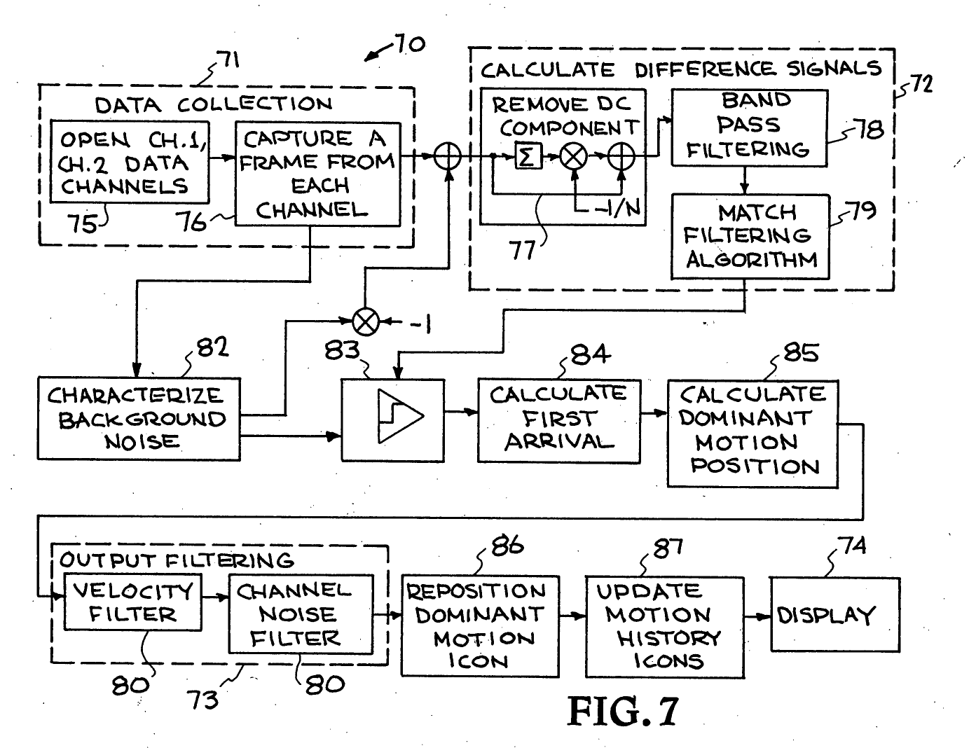

Referring now to FIG. 7, a block diagram illustrating signal and image processing algorithms used in the detection and tracking system of the present invention is shown. The signal and image processing algorithms are designated generally by the reference numeral 70.

The signal and image processing algorithms 70 include the following sub-components: data collection 71, calculate different signals 72, output filtering 73, and display 74. The data collection following sub-component 71 includes open ch1, ch2 data channels component 75 and capture a frame from each channel component 76. The calculate different signals sub-component 72 includes remove dc component 77, band pass filtering component 78, and match filtering algorithm 79. The output filtering sub-component 73 includes velocity filter 80 and channel noise filter 81.

An azimuth estimate of a moving object can be calculated by signal and image filtering algorithms using multiple frame processing, non-stationary signal processing techniques, and triangulation using methods such as the Law of Cosines. This gives the ability to track a moving object precisely in space.

Tracking the object allows focusing the range gate of a radar unit continuously to the moving target. This, in turn allows the continuous integration of localized spatial motion activity. Spectral estimation techniques are then used to estimate heartbeat and respiration rates. Signal and image processing algorithms are performed on a standard notebook computer, embedded DSP processor or similar device.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. An apparatus for detection and tracking of an individual or animal, comprising:
a first low power ultra wideband radar unit that produces a first return radar signal from the individual or animal,
a second low power ultra wideband radar unit that produces a second return radar signal from the individual or animal, said second low power micro-power radar unit located a fixed distance from said first low power ultra wideband radar unit, and
a processing system for said first return radar signal and said second return radar signal for detection and tracking of the individual or animal.

2. The apparatus for detection and tracking of an individual or animal of claim 1 wherein the individual or animal is located in a structure and including structure for positioning said first low power ultra wideband radar unit and said second low power ultra wideband radar unit against or proximate said structure.

3. The apparatus for detection and tracking of an individual or animal of claim 1 wherein the individual or animal is located in a structure and including fixation units for positioning said first low power ultra wideband radar unit and said second low power ultra wideband radar unit against said structure.

4. The apparatus for detection and tracking of an individual or animal of claim 1 wherein the individual or animal is located in a structure and including a frame that positions said first low power ultra wideband radar unit and said second low power ultra wideband radar unit against or proximate said structure.

5. The apparatus for detection and tracking of an individual or animal of claim 1 wherein the individual or animal is located in a structure and including a frame and tripod that positions said first low power ultra wideband radar unit and said second low power ultra wideband radar unit against or proximate said structure.

6. The apparatus for detection and tracking of an individual or animal of claim 1 wherein the individual or animal is located in a structure and including a robot that positions said first low power ultra wideband radar unit and said second low power ultra wideband radar unit against or proximate said structure.

7. The apparatus for detection and tracking of an individual or animal of claim 1 including a wireless system that connects said first low power ultra wideband radar unit, said second low power ultra wideband radar unit and said processing system.

8. The apparatus for detection and tracking of an individual or animal of claim 1 wherein said a first low power ultra wideband radar unit and said second low power ultra wideband radar unit produce return radar signals representing the respiration of the individual or animal.

9. The apparatus for detection and tracking of an individual or animal of claim 1 wherein said a first low power ultra wideband radar unit and said second low power ultra wideband radar unit produce return radar signals representing the respiration of the individual or animal and wherein said processing system produces a signal representing the respiration of the individual or animal.

10. The apparatus for detection and tracking of an individual or animal of claim 1 wherein said processing system provides a radar analog output signal that is proportional to motion at a set range.

11. The apparatus for detection and tracking of an individual or animal of claim 1 wherein said processing system includes signal and image processing algorithms that can be performed on a notebook computer.

12. The apparatus for detection and tracking of an individual or animal of claim 1 wherein said processing system includes signal and image processing algorithms that can be performed on an embedded DSP processor.

13. The apparatus for detection and tracking of an individual or animal of claim 1 including a geo-location system for detection and tracking of the individual or animal.

14. The apparatus for detection and tracking of an individual or animal of claim 13 wherein said geo-location system is connected to satellite-based GPS.

15. The apparatus for detection and tracking of an individual or animal of claim 13 wherein said geo-location system is connected to low-earth-orbit satellites.

16. The apparatus for detection and tracking of an individual or animal of claim 13 wherein said geo-location system is connected to geosynchronous satellites.

17. An apparatus for detection and tracking of an individual or animal, comprising:
first low power ultra wideband radar means for producing a first return radar signal from the individual or animal,
second low power ultra wideband radar means for producing a second return radar signal from the individual or animal, said second low power micro-power radar means located a fixed distance from said first low power ultra wideband radar means, and
processing system means for processing said first return radar signal and said second return radar signal for detection and tracking of the individual or animal.

18. The apparatus for detection and tracking of an individual or animal of claim 17 wherein said a first low power ultra wideband radar means and said second low power ultra wideband radar means produce return radar signals representing the respiration of the individual or animal.

19. The apparatus for detection and tracking of an individual or animal of claim 17 wherein said processing means produces a signal representing the respiration of the individual or animal.

20. The apparatus for detection and tracking of an individual or animal of claim 17 wherein said processing means provides a radar analog output signal that is proportional to motion at a set range.

21. The apparatus for detection and tracking of an individual or animal of claim 17 wherein said processing means includes signal and image processing algorithms that can be performed on a standard notebook computer.

22. The apparatus for detection and tracking of an individual or animal of claim 17 wherein said processing means includes signal and image processing algorithms that can be performed on an embedded DSP processor.

23. The apparatus for detection and tracking of an individual or animal of claim 17 including a geo-location system for detection and tracking of the individual or animal.

24. The apparatus for detection and tracking of an individual or animal of claim 23 wherein said geo-location system is connected to satellite-based GPS.

25. The apparatus for detection and tracking of an individual or animal of claim 23 wherein said geo-location system is connected to low-earth-orbit satellites.

26. The apparatus for detection and tracking of an individual or animal of claim 23 wherein said geo-location system is connected to geosynchronous satellites.

27. A method of detecting and tracking an individual or animal, comprising the steps of:
producing a first return radar signal from the individual or animal with a first low power ultra wideband radar,
producing a second return radar signal from the individual or animal with a second low power ultra wideband radar,
maintaining said first low power micro-power radar a fixed distance from said second low power ultra wideband radar, and
processing said first return radar signal and said second return radar signal in detecting and tracking of the individual or animal.

28. The apparatus for detection and tracking of an individual or animal of claim 27 wherein said step of producing a first return radar signal from the individual or animal with a first low power ultra wideband radar comprises producing a first return radar signal from the individual or animal with a first low power ultra wideband radar representing the heartbeat of the individual or animal.

29. The apparatus for detection and tracking of an individual or animal of claim 27 wherein step of processing said first return radar signal and said second return radar signal comprises producing a signal representing the heartbeat of the individual or animal.

30. The apparatus for detection and tracking of an individual or animal of claim 27 wherein step of processing said first return radar signal and said second return radar signal comprises producing a signal representing the respiration of the individual or animal.

31. The apparatus for detection and tracking of an individual or animal of claim 27 wherein said step of processing said first return radar signal and said second return radar signal provides a radar analog output signal that is proportional to motion at a set range.
